(19) United States
(12) Patent Application Publication
(10) Pub. No.: US 2025/0034288 A1
(43) Pub. Date: Jan. 30, 2025

(54) PRODUCTION OF HIGHLY FUNCTIONALIZED POLYSACCHARIDES WITH IMPROVED BIODEGRADABILITY

(71) Applicant: SPECIALTY OPERATIONS FRANCE, Lyon (FR)

(72) Inventors: Philippe Marion, Vernaison (FR); Matthieu Corbet, Vourles (FR); Elie Derrien, Brignais (FR); Valérie Rizzo, Princeton Junction, NJ (US); Minrui Xu, Lyon (FR)

(73) Assignee: SPECIALTY OPERATIONS FRANCE, Lyon (FR)

(21) Appl. No.: 18/715,601

(22) PCT Filed: Nov. 24, 2022
(86) PCT No.: PCT/EP2022/083081

§ 371 Date: Jun. 3, 2024

(30) Foreign Application Priority Data
Dec. 1, 2021 (EP) 21211622.2

(51) Int. Cl. C08B 37/00

(52) U.S. Cl. CPC C08B 37/0096

(57) ABSTRACT

The invention relates to functionalized polysaccharides and a production process thereof having improved biodegradability and performance properties, such as flocculation ability, for home and personal care applications.

### TECHNICAL FIELD

The invention relates to functionalized polysaccharides and a production process thereof having improved biodegradability and performance properties, such as flocculation ability, for home and personal care applications.

This application claims priority(ies) filed on 1 Dec. 2021 in EUROPE with Nr 21211622.2, the whole content of this application being incorporated herein by reference for all purposes.

### TECHNICAL BACKGROUND

Functionalized polysaccharides, for example cationic polysaccharides, have been used widely in personal care and household products, like hair and skincare products or in dishwashing detergents to provide thickening, conditioning, anti-spotting and/or anti-filming effects. Suitable functionalized polysaccharides for such applications are described for instance in US 2003/0211952, US 2013/0310298, US 2014/0302213, US 2011/0003936 or WO 2013/011122.

Functionalized polysaccharides can be also used as additives for increasing the available water capacity on soil as described in US 2011/0003936, or as thickening agents in textile industry or in the pharmaceutical and cosmetic field, as binding agents in the paper industry, as flocculation agents in ore production, or as emulsifiers and co-stabilizers in foodstuffs.

However, one problem of these functionalized polysaccharides is their poor biodegradability, which makes their use in particular in home and personal care products problematic.

Several production processes for functionalizing polysaccharides to obtain functionalized polysaccharides showing specific performance properties are known in the prior art. Usually, the polysaccharide skeleton is grafted (functionalized) by reaction of some of its deprotonated alcohol groups with an epoxide bearing a quaternary ammonium group (see for example, M.-P. Labeau, P. Marion, F. Monnet et al., “Chemicals and Fuels from Bio-Based Building Blocks”, Wiley, 2016, pp 615-642). Some production processes also deal with nucleophilic substitution on alkyl chlorides.

However, by using these processes, the functionalization of the polysaccharide is often not sufficient and versatile to get variable structures and/or the polysaccharide is partially degraded, i.e. its molecular weight is reduced. This results into functionalized polysaccharides having poor performance properties, e.g. flocculation ability, and, as mentioned above, a poor biodegradability.

Therefore, there was the need to develop a novel synthetic method able to tune both the degree of substitution (DS) and the molar weight (M_{w}) of the polysaccharide, and thus to obtain functionalized polysaccharides having improved properties including biodegradability and flocculation ability.

### SUMMARY OF THE INVENTION

The present invention relates to a grafted polysaccharide having the formula I

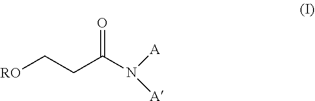

wherein
RO is a deprotonated polysaccharide group,
A is —(CR′R″)ₙ-A″,
A′ is H, alkyl (preferably C₁-C₄) or A, wherein when A′ is A the two As are identical or different,
R′ and R″, which are identical or different at each occurrence, are H or an alkyl group,
n is an integer from 1 to 20,
A″ is either NR₁R₂, N⁺R₁R₂R₃ or (CR₄R₅)ₘXOₖY, wherein
R₁, R₂ and R₃, which are identical or different, are selected from the group consisting of H, aliphatic, cycloaliphatic, aryl-aliphatic groups, optionally substituted and/or interrupted by one or more heteroatoms or heteroatom containing groups, and heteroaliphatic cycle formed by R₁ and R₂ with the N atom,
R₄ and R₅, which are identical or different, are selected from the group consisting of hydrogen or an alkyl group, optionally substituted and/or interrupted by one or more heteroatoms or heteroatom containing groups,
m is an integer from 1 to 20,
X is O, C or S,
k is 0, 2 or 3,
and
Y is H, a C₁-C₆ alkyl group or a negative charge.

Preferably, the deprotonated polysaccharide is a deprotonated galactomannan or derivatives thereof, preferably a deprotonated guar.

Furthermore, the invention relates to a production process for producing the grafted polysaccharide, wherein a deprotonated polysaccharide of formula RO⁻ reacts with a functionalization agent of formula II

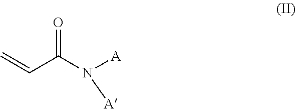

wherein RO, A and A′ are as defined above.

In particular, according to the invention, in a first production process step a polysaccharide is deprotonated to obtain the deprotonated polysaccharide and in a second step the deprotonated polysaccharide reacts with the functionalization agent of formula II.

The obtained grafted polysaccharide exhibits a high diversity with the possibility to combine different natures of polysaccharides, in particular different natures of guars (native guars, cationic guars, carboxyalkyl guars e.g. carboxymethyl guar (CMG), hydroxyalkyl guar e.g. hydroxypropyl guar (HPG), carboxyalkyl hydroxyalkyl guars e.g. carboxymethyl hydroxypropyl guar (CMHPG), etc.) with various grafting agents, being anionic, non-ionic, cationic or even zwitterionic.

In a further reaction, if A″ of the grafted polysaccharide of formula I is NR₁R₂ as defined above, the tertiary amino group of the substituent NR₁R₂ can be quaternized with the aid of a quaternization agent having the formula III

X′—R₆ (III),

wherein
X′ is a leaving group and
R₆ is a moiety selected from the group consisting of aliphatic, aromatic, alkyl-aryl, and alcohol groups, optionally substituted and/or interrupted by one or more heteroatoms or heteroatom containing groups, to obtain a quaternized polysaccharide.

The grafted polysaccharides of the invention can be used in home and personal care applications as for example flocculation agents.

It has been demonstrated that by using the process of the invention the degree of substitution (DS) and the molecular weight (M_{w}) of the functionalized polysaccharides according to the invention can be controlled so that for example the biodegradability and flocculation ability of the functionalized polysaccharides are improved. In particular, the process of the invention provides functionalized polysaccharides having a relative high DS while maintaining their good biodegradability.

Without bounding on any theory, it is assumed that the incorporation of an intermediate cleavable linker in the polysaccharide backbone results into an easier release of the low molecular weight functionalized moiety that favours biodegradability of the grafted polysaccharide.

Additionally, the tertiary amine function of the functionalized polysaccharide according to the invention, i.e. A″ is NR₁R₂, has a pH dependent cationicity (and thus can be in the form of N⁺HR₁R₂,Cl⁻) and surprisingly shows a very good acceptability by microorganisms responsible for biodegradation compared to standard cationic polysaccharides (bearing a function N⁺Me₃,Cl⁻).

Moreover, this tertiary amine can be post-modified, especially, as mentioned above, can be quaternized, by shifting for examples from pH dependent cationicity (cationic at pH below 10) to pH independent intrinsic cationicity. By quaternizing with specific functionalization agents on the tertiary amine function, both the applicative performance and the inherent acceptability by microorganisms responsible for biodegradation are surprisingly improved compared to standard cationic polysaccharides (bearing a function N⁺Me₃,Cl⁻).

Furthermore, while changing the nature of the environment of the quaternized amine function of the functionalized polysaccharide, it is possible to modulate the biodegradability of the polysaccharide, at a fixed DS. Typically, when the quaternized amine function is bearing a polar head, for example an alcohol group, SO₃⁻ or CO₂⁻, the biodegradability of the polysaccharide can be improved.

The new approach allows finding novel eco-designed products giving performances and biodegradability.

The present invention also refers to a composition, preferably a home and personal care composition, comprising at least a grafted polysaccharide of formula (I) according to the invention.

### DETAILED DESCRIPTION OF THE INVENTION

Before the issues of the invention are described in detail, the following should be considered:

As used herein, the singular forms “a”, “an”, and “the” include both singular and plural referents unless the context clearly dictates otherwise. By way of example, “a compound” means one compound or more than one compound.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Throughout this application, the term “about” is used to indicate that a value includes the standard deviation of error for the device or method being employed to determine the value.

As used herein, the term “average” refers to number average unless indicated otherwise.

As used herein, the terms “% by weight”, “wt.-%”, “weight percentage”, or “percentage by weight”, and the terms “% by volume”, “vol.-%”, “volume percentage”, or “percentage by volume”, are used interchangeably.

The recitation of numerical ranges by end points includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The terms “functionalized” and “grafted” as used herein are interchangeable.

Preferably, the functionalized/grafted polysaccharide according to the invention is a non-ionic, a cationic, an anionic or a zwitterionic polysaccharide, more preferably the functionalized/grafted polysaccharide is a cationic polysaccharide.

Should the disclosure of any patents, patent applications, and publications which are incorporated herein by reference conflict with the description of the present application to the extent that it may render a term unclear, the present description shall take precedence.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different alternatives, embodiments and variants of the invention are defined in more detail. Each alternative and embodiment so defined may be combined with any other alternative and embodiment, and this for each variant unless clearly indicated to the contrary or clearly incompatible when the value range of a same parameter is disjoined. In particular, any feature indicated as being preferred or advantageous may be combined with any other feature or features indicated as being preferred or advantageous.

Furthermore, the particular features, structures or characteristics described in the present description may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art.

The present invention refers to a grafted polysaccharide characterized by the following formula (I):

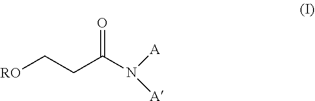

wherein
RO is a deprotonated polysaccharide group,
A is —(CR′R″)ₙ-A″,
A′ is H, methyl or A, wherein when A′ is A the two As can be identical or different,
R′ and R″, which are identical or different at each occurrence, are H or an alkyl group,
n is an integer from 1 to 20,
A″ is either NR₁R₂, N⁺R₁R₂R₃ or (CR₄R₅)ₘXOₖY, wherein R₁, R₂ and R₃, which are identical or different, are selected from the group consisting of H, aliphatic, cycloaliphatic, aryl-aliphatic groups, optionally substituted and/or interrupted by one or more heteroatoms or heteroatom containing groups, and heteroaliphatic cycle formed by R₁ and R₂ with the N atom,
R₄ and R₅, which are identical or different, are selected from the group consisting of hydrogen or an alkyl group, optionally substituted and/or interrupted by one or more heteroatoms or heteroatom containing groups,
m is an integer from 1 to 20,
X is O, C or S,
k is 0, 2 or 3,
and
Y is H, a C₁-C₆ alkyl group (preferably methyl) or a negative charge.

The grafted polysaccharide of the invention has a desired functionality and an improved biodegradability and flocculation ability. Furthermore, by using the process of the invention, it is possible to control the average molecular weight of the grafted polysaccharide in a broad range, i.e. from low to high average molecular weights.

In one embodiment of the invention, the polysaccharide that is grafted is a polysaccharide and derivatives thereof selected from the group consisting of galactomannan, glucomannan, agar, dextran, polyglucose, polyaminoglycan, xanthan polymers, hemicelluloses (xyloglycans, xyloglucans, mannoglycans and mixed-linkage β-glucans), pectins (D-galacturonan), and starch. Preferably, the polysaccharide is a galactomannan and derivatives thereof.

Galactomannans are polysaccharides composed principally of galactose and mannose units, wherein the mannose units are linked in a 1-4-β-glycosidic linkage and the galactose branching takes place by means of a 1-6-α-linkage to mannose units. The galactomannans are usually found in the endosperm of leguminous seeds such as guar, locust bean, honey locust, flame tree and the like.

In a more preferred embodiment of the invention, the galactomannan and derivatives thereof is selected from the group consisting of fenugreek gum, mesquite gum, guar gum, tara gum, locust bean gum, cassia gum, daincha gum, konjac gum and their derivatives such as hydroxyalkyl guar, carboxyalkyl guar, carboxyalkyl hydroxyalkyl guar, cationic guar, hydrophobically modified guar, hydrophobically modified hydroxyalkyl guar, hydrophobically modified carboxyalkyl guar, hydrophobically modified carboxyalkyl hydroxyalkyl guar, and mixtures thereof. Most preferably, the polysaccharide is a guar or a guar derivative. The terms “polysaccharide”, “galactomannan” and “guar” as used herein also refers to their derivatives as for example listed above.

According to the invention, the substituent A of the grafted polysaccharide of formula I is —(CR′R″)ₙ-A″, wherein n is an integer from 1 to 20, preferably from 1 to 10, 1 to 5, more preferably n is 2 or 3.

R′ and R″ are identical or different at each occurrence and are H or an alkyl group, preferably a linear C₁-C₄ alkyl group. More preferably R′ and R″ are both hydrogen or methyl.

Furthermore, according to the invention, A″ of the substituent —(CR′R″)ₙ-A″ is either NR₁R₂, N⁺R₁R₂R₃ or (CR₄R₅)ₘXOₖY, wherein R₁, R₂ and R₃, which are identical or different, are selected from the group consisting of H, aliphatic, cycloaliphatic, arylaliphatic groups, optionally substituted and/or interrupted by one or more heteroatoms or heteroatom containing groups, and heteroaliphatic cycle formed by R₁ and R₂ with the N atom, R₄ and R₅, which are identical or different, are selected from the group consisting of hydrogen or an alkyl group, optionally substituted and/or interrupted by one or more heteroatoms or heteroatom containing groups, m is an integer from 1 to 20, X is O, C or S, k is 0, 2 or 3, and Y is hydrogen, a C₁-C₆ alkyl group (preferably methyl) or a negative charge.

Preferably, R₁ and R₂ are linear alkyl groups, more preferably a linear C₁ to C₄ alkyl groups, most preferably R₁ and R₂ are methyl groups.

R₃ is preferably hydrogen or a linear or branched C₁-C₁₀ or C₁-C₈ alkyl group, most preferably R₃ is a linear C₁-C₄ alkyl group, which is optionally substituted and/or interrupted by one or more heteroatoms or heteroatom containing groups, preferably O, N and/or S heteroatoms. Even more preferred, R₃ is selected from group consisting of H, —(CH₂—CH₂O)₂—H, —(CH₂)₃—OH, —CH₂—CH(OH)—CH₂—OH, —CH₂-Ph, —CH₂—COO—, —CH₂—CH(OH)—CH₂—SO₃⁻, —CH₂—CH₂—SO₃, —CH₂—CH(OH)—CH₂—N+(CH₃)₃, and —CH₂—CO—NH—CH₂—CH₂—CH₂—N+(CH₃)₂—CH₂—CH(OH)—CH₂—N+(CH₃)₃.

Furthermore, preferably R₄ and R₅ are independently from each other hydrogen or a linear C₁-C₄ alkyl group, which are optionally substituted and/or interrupted by one or more heteroatoms or heteroatom containing groups, preferably O, N and/or S heteroatoms.

Additionally, it is preferred that m is an integer from 1 to 3. Furthermore, it is preferred that
if X is O, k is 0;
if X is C, k is 2; and
if X is S, k is 3.

According to the invention, if A″ is NR₁R₂, this group may be shifted to N⁺R₁R₂R₃ by protonation in an environment having a pH equal or below pKₐ of the amine group, i.e. the pH≤10. In that case, R₃ is hydrogen. In one embodiment of the invention, A″ is N⁺R₁R₂R₃, wherein
R₁ and R₂ are linear alkyl groups, preferably linear C₁ to C₄ alkyl groups, more preferably methyl groups and R₃ is selected from aliphatic, cycloaliphatic, arylaliphatic groups, preferably R₃ is a linear or branched C₁-C₁₀ or C₁-C₈ alkyl group, more preferably a linear C₁-C₄ alkyl group, which are optionally substituted and/or interrupted by one or more heteroatoms or heteroatom containing groups, preferably O, N and/or S heteroatoms.

In another preferred embodiment of the invention A″ is (CR₄R₅)ₘCO₂Y or (CR₄R₅)ₘSO₃Y.

The substituent A′ of the grafted polysaccharide of formula I is H, alkyl (preferably methyl) or A as defined above. When A′ is A, the two substituents A can be identical or different. In a preferred embodiment of the invention A′ is hydrogen.

In a further preferred embodiment of the invention, the grafted polysaccharide is a grafted polysaccharide of formula I, wherein RO is a deprotonated guar group, A′ is H, R′ and R″ of substituent A —(CR′R″)ₙ-A″ are both H, n is 2 or 3, and A″ is N⁺R₁R₂R₃ wherein R₁ and R₂ being methyl groups and R₃ being selected from group consisting of H, —(CH₂—CH₂O)₂—H, —(CH₂)₃—OH, —CH₂—CH(OH)—CH₂—OH, —CH₂-Ph, —CH₂—COO—, —CH₂—CH(OH)—CH₂—SO₃⁻, —CH₂—CH₂—SO₃⁻, —CH₂—CH(OH)—CH₂—N+(CH₃)₃, and —CH₂—CO—NH—CH₂—CH₂—CH₂—N+(CH₃)₂—CH₂—CH(OH)—CH₂—N+(CH₃)₃. Additionally, it is preferred that in the grafted polysaccharide of formula I, RO is a deprotonated guar group, A′ is H, R′ and R″ of substituent A —(CR′R″)ₙ-A″ are both methyl, A″ is (CR₄R₅)ₘSO₃Y, wherein R₄ and R₅ are both hydrogen, m is an integer from 1 to 3 and Y is hydrogen or a negative charge.

Furthermore, it is preferred that the average molecular weight of the grafted polysaccharide is from 20,000 g/mol to 2,500,000 g/mol, preferably from 20,000 g/mol to 2,000,000 g/mol, more preferably, from 50,000 g/mol to 1,800,000 g/mol, or 80,000 g/mol to 1,500,000 g/mol, 100,000 g/mol to 1,350,000 g/mol, or even more preferred from 500,000 g/mol to 1,200,000 g/mol.

The average molecular weight of the grafted polysaccharide may be measured by SEC-MALS (Size Exclusion Chromatography with Multi-Angle Light-Scattering detection). A value of 0.140 for dn/dc is used for the molecular weight measurements. A Wyatt MALS detector is calibrated using a 22.5 kDa polyethylene glycol standard. All calculations of the molecular weight distributions are performed using Wyatt's ASTRA software. For cationic polysaccharides, in particular for cationic guars, the samples are prepared as 0.05% solutions in the mobile phase (100 mM Na₂NO₃, 200 ppm NaN₃, 20 ppm pDADMAC) and filtered through 0.45 m PVDF filters before analysis. 100 μL of the filtered solution are injected and then go through a pre-column plus 3 columns OH pak LB-806 M at 35° C. For non-ionic and anionic polysaccharides, in particular for non-ionic and anionic guars, the samples are prepared as 0.05% solutions in the mobile phase (100 mM Na₂NO₃, 200 ppm NaN₃) and filtered through 0.45 m PVDF filters before analysis. 100 μL of the filtered solution are injected and go through a pre-column plus 3 columns OH pak LB-806 HQ at 35° C.

The degree of substitution (DS) of the grafted polysaccharide according to the invention is preferably between 0.05 and 1.0, more preferably between 0.08 and 0.50, even more preferred between 0.10 and 0.4 or between 0.15 and 0.3 in particular preferred between 0.10 and 0.25, notably between 0.05 and 0.25.

The term “degree of substitution” or “substitution degree” (DS), as used herein, refers to the level of substitution for polysaccharides, means the average amount of hydroxyl groups on polysaccharides that are substituted by or functionalized with the target functional group for single sugar unit. The DS of the polysaccharide is determined by ¹H NMR spectroscopy.

The grafted polysaccharide of the invention can be obtained by reacting (condensation) a deprotonated polysaccharide (RO⁻), as defined above, with a functionalization agent (FA) of formula II

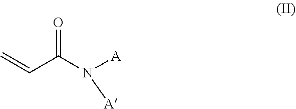

wherein A and A′ are as defined above.

According to the invention, in a first process step, the polysaccharide, as defined above, is deprotonated.

In order to increase the availability of the polysaccharide and to avoid a possible gelation of the reaction mixture during deprotonation of the polysaccharide, the polysaccharide may be mixed with a complexing agent prior conducting the deprotonation reaction. The complexing agent is preferably a complexing agent selected from the group consisting of dialdehydes such as glyoxal, glutaraldehyde or veratraldehyde, trisodium trimetaphosphate (STMP), boric acid and derivatives like borax, metallic species such as titanates, zirconates, Cu(II), Sb(III), Ti(IV), Zr(IV), which are for example alkoxy based. More preferably, the complexing agent is a metallic complexing agent, even more preferred the complexing agent is Borax.

For deprotonation, the polysaccharide is swollen with both water and an alkaline aqueous solution comprising a base for deprotonation reaction of the polysaccharide. This can be done in one pot or separately.

The swelling of the polysaccharide with water results into a swollen polysaccharide (polymer). In order to control the physicochemistry of the swollen state of the polymer, the weight ratio of total water content, i.e. the water of the alkaline aqueous solution and the complementary amounts of water, to the polysaccharide is preferably between 0.5 and 3.0 g/g, preferably between 0.5 and 2.0 g/g, more preferably between 0.5 and 1.1 g/g. If the amount of water is too high, too much slippery agglomeration are formed (typically have a paste or a slurry and that should be avoided) and therefore the grafting is not uniform on the polysaccharide, and if the water content is too low, no swollen state of the polysaccharide is obtained thus the reaction cannot occur properly and the targeted DS is not reached. In both cases, the polysaccharide is not accessible well enough for the reaction to occur properly.

The polysaccharide is additionally swollen with an alkaline aqueous solution comprising a base that catalyzes the deprotonation of the polysaccharide. The base is preferably a strong base and soluble in water. The base may be selected from the group consisting of sodium hydroxide, potassium hydroxide, sodium methoxide, 1,4-diazabicyclo[2.2.2]octane (DABCO), triethylamine (TEA), sodium carbonate (Na₂CO₃), pyridine (C₅H₅N), sodium bicarbonate (NaHCO₃), potassium carbonate (K₂CO₃), potassium bicarbonate (KHCO₃), sodium ethoxide, and potassium tert-butoxide. Preferably, the base is sodium hydroxide.

The alkaline aqueous solution comprises the base in a sufficient amount to deprotonate the polysaccharide, preferably, the alkaline aqueous solution consists of the base in a sufficient amount and water. In order to ensure that the base is used in a sufficient amount to deprotonate the polysaccharide, the molar ratio of the base to the anhydroglucose unit (AGU) of the deprotonated polysaccharide is preferably from 0.1 to 1.5 mol/mol, from 0.1 to 1.0 mol/mol, notably from 0.1 to 0.5 mol/mol, and particularly from 0.15 to 0.25 mol/mol.

The inventors of the invention found that the use of lower amounts of base than used in the prior art results into an efficient functionalization of the polysaccharide and minimize the molecular weight degradation (depolymerisation) of the polysaccharide.

The deprotonation of the polysaccharide according to the invention should be carried out at a temperature that ensures that the polysaccharide is not depolymerized. Therefore, it is preferred that the deprotonation reaction is carried out at a temperature of 0 to 80° C., more preferably at a temperature of 20 to 75° C., even more preferred at a temperature of 50 to 70° C.

The deprotonation reaction is preferably carried out for a duration of at least 0.5 hours. If it is desired, the reaction is carried out until the polysaccharide is completely deprotonated, which is usually the case after 3 hours. According to the invention, the deprotonation reaction is carried out preferably for a duration of 0.5 to 3.5 hours, of 1.0 to 3.0 hours, more preferably of 1.0 to 2.5 hours, even more preferred of 1.0 to 1.5 hours.

Afterwards, the functionalization agent (FA) of formula II is added to the reaction mixture. It is preferred that functionalization agent is added dropwise to the reaction mixture to start the reaction, which is a so-called oxa-Michael addition. Such a type of reaction is for example described in US 2019/0127316. In said document, an amido alkyl betaine is synthesized from a linear alcohol having from 8 to 22 carbon atoms. It was unknown in the prior art that instead of a linear alcohol also a polysaccharide can be used to obtain an amide amine polysaccharide.

The oxa-Michael addition reaction is carried out in the same pot as the deprotonation reaction or separately. If the oxa-Michael addition reaction is carried out in the same pot, a sufficient mechanical stirring is necessary in order to avoid gelation of the reaction mixture.

It is preferred that the molar ratio of the functionalization agent to the anhydroglucose unit (AGU) of deprotonated polysaccharide is between 0.05 and 3 mol/mol, preferably between 0.08 and 2.5 mol/mol, 0.10 and 2.0 mol/mol, more preferably between 0.15 and 1.5 mol/mol or 0.15 and 1.0 mol/mol, even more preferred between 0.15 and 0.50 mol/mol.

It has been found that the grafting efficiency of the reaction is better when the ratio of the functionalization agent to the anhydroglucose unit (AGU) of the deprotonated polysaccharide is low. The grafting efficiency, also called DS efficiency, is defined as DSᵣₑₐₗ/DS_{theoretical}.

The oxa-Michael addition is preferably carried out at temperature of 50 to 80° C., preferably of 55 to 75° C., more preferably at a temperature of 60 to 70° C., in order to avoid depolymerisation of the polysaccharide. Additionally, it is preferred that the reaction is carried out for a duration of at least 2 hours, preferably of at least 3 or 4 hours, more preferably the reaction is carried out for a duration of 2 to 48 hours depending on the yield to be achieved. It is particularly preferred that the reaction is carried out for at least 6 hours to get the right compromise between the desired average molecular weight (M_{w}), in particular a high M_{w}, and a high DS efficiency.

The obtained solid product, i.e. the grafted polysaccharide is washed to remove undesired salts, side products and unreacted reagents from the product. The washing step is preferably carried out with a solution of isopropanol and water or of ethanol and water having preferably a ratio of isopropanol/ethanol to water of (70 to 75) to (30 to 25) vol.-% (v/v). Afterwards, the washed grafted polysaccharide is dried, preferably at approx. 50° C. under atmospheric pressure.

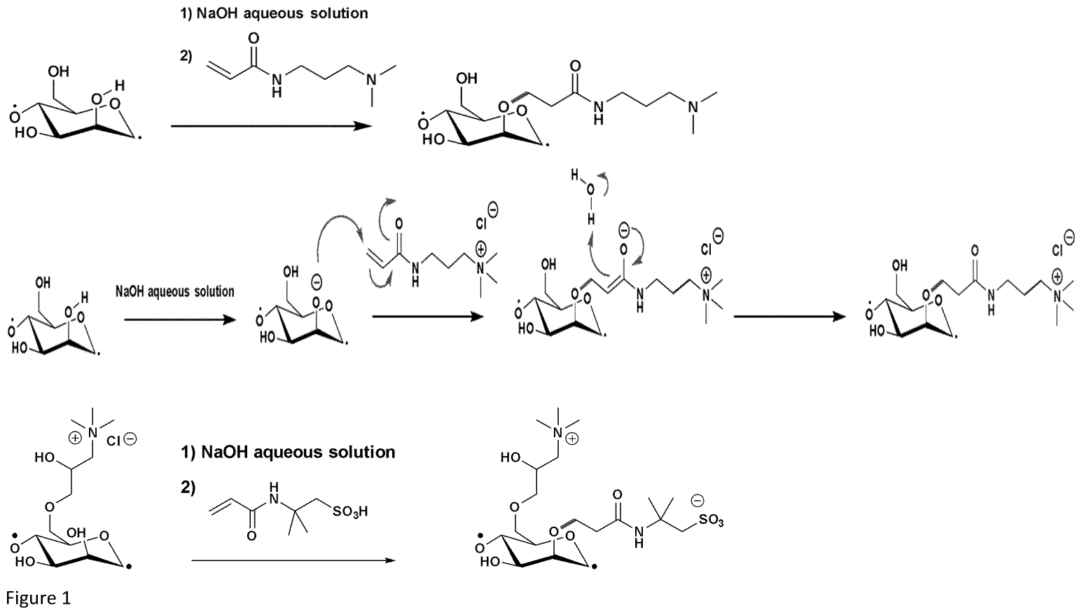

In FIG. 1 the process of the invention is depicted.

The obtained grafted polysaccharide can be a non-ionic, a cationic, an anionic or a zwitterionic polysaccharide as shown for example in FIG. 1.

According to the invention, if A″ of the grafted polysaccharide of formula I is NR₁R₂, a further reaction can be carried out, wherein the tertiary amine group of the substituent A″ is quaternized to obtain a grafted polysaccharide having a cationic charge. Quaternization reactions are well-known on small molecules like synthesis of quaternary amine surfactants in homogeneous medium but they are challenging on macromolecules because the post-modification of polymers is usually carried out in heterogeneous media due to the limited solubility of polymers in solvent and thus it does not often lead to a high conversion. In the case of the present invention, this post-modification on the grafted polysaccharide of formula I (with A″ of the grafted polysaccharide of formula I is NR₁R₂) is possible to achieve a high conversion and selectivity close to 100%.

Thereby, the grafted polysaccharide of the invention is swollen with water, preferably in weight ratio of water to grafted polysaccharide of 0.5 to 1.5 g/g, more preferably of 1.0 g/g.

Afterwards, a quaternization agent is added to the mixture. The quaternization agent has the formula (III)

X′—R₆ (III),

wherein
X′ is a leaving group, preferably selected from the group consisting of halogen, tosylate, perfluoroalkylsulfonates e.g. triflate, mesylate and their like, and R₆ is a moiety selected from the group consisting of aliphatic, aromatic, alkylaryl groups, and alcohol groups, preferably ethoxy or propyloxy groups, optionally substituted and/or interrupted by one or more heteroatoms or heteroatom containing groups.

Preferably, the quaternization agent is an alkyl halide, such as an alkyl chloride, which may encompass alcohols function. In particular it is preferred that the quaternization agent is selected from the group consisting of 2-(2-chloroethoxy)ethanol (CLEE); 3-chloro-1-propanol (CP); (±)-3-chloro-1,2-propanediol (CPD); ((3-chloro-2-hydroxypropyl)trimethylammonium chloride; sodium chloroacetate, sodium 3-chloro-2-hydoxypropane-1-sulfonate; sodium 2-chloroethanesulfonate and benzyl chloride (ClBn).

It is further preferred that the molar ratio of the quaternization agent to the tertiary amine of the grafted polysaccharide is between 1.0 and 7.0 mol/mol, more preferably between 1.2 and 5.0 mol/mol, even more preferred between 1.5 and 2.0 mol/mol.

The quaternization reaction is carried out at a temperature between 5° and 80° C., preferably between 55 and 80° C., more preferably between 6° and 75° C.

Additionally, it is preferred that the reaction is carried out for a duration of at least 6 hours, preferably for a duration between 6 and 20 hours, more preferably between 10 and 18 hours or between 15 and 17 hours.

Afterwards, the obtained product, i.e. the functionalized polysaccharide, is washed to remove undesired salts, side products and unreacted reagents, for example with a solution of isopropanol and water, as described above, and then dried at a temperature approx. 50° C. under atmospheric pressure. The degree of quaternization can be determined by ¹H NMR spectroscopy.

The inventors of the invention observed that the average molecular weight of the obtained functionalized polysaccharide can be conserved during the quaternization reaction. Furthermore, the obtained polysaccharide comprises a quaternary ammonium moiety independently from the pH of its environment.

The functionalized polysaccharides of the invention can be used in home personal care applications, for example as a flocculation agent.

Home and personal care compositions such as conditioning shampoos, shower gel and fabric care compositions containing conditioning agents of various types have been disclosed before and are well known by the man skilled in the art to allow for the cleaning and conditioning of hair, skin and fabric.

Personal care composition means anything done that is of a personal nature. This may include compositions used for bathing and showering, including bed-baths, lotions and creams notably for skin care, oral hygiene, make-up, and hair care. Specifically compositions of the invention may be a skin care composition, such as shower gel, soap, hydrogel, cream, lotion or balm, or a hair care composition, such as shampoo, rinse off conditioner, leave-in conditioner, gel, pomade or cuticle coat.

Home care composition shall include general household cleaning products for example, toilet bowl cleaners, laundry detergents, fabric softeners, dishwashing liquid, bathroom cleaner and surface cleaner.

These compositions may also comprise aesthetic modifiers, conditioning agents, rheology modifiers, film-formers, chelates, emulsifiers, moisturizers, emollients, surfactants (such as anionic, cationic, nonionic, amphoteric, zwitterionic surfactants, or combinations thereof), propellants, stabilizers, preservatives, cleansing and suspending/gelling agents, and active ingredients.

Notably these compositions, preferably personal care compositions of the present invention comprises one or more “benefit agents” that is, materials that provide a care benefit, such as moisturizing or conditioning, such as, for example, emollients, oils, moisturizers, humectants, conditioners, polymers, vitamins, abrasives, UV absorbers, antimicrobial agents, anti-dandruff agents, fragrances, and/or appearance modifying additives, such as, for example, colored particles or reflective particles, which may be in the form of a solid, liquid, or gas and may be insoluble or are only partly soluble in the composition. Mixtures of the benefit agents may be used.

The examples that follow are intended for illustrating the invention in more detail.

### EXAMPLES

All starting materials used in the examples are commercially available.

### Part I: Synthesis of Amide Amine Guar

### Example 1

### Synthesis of a Non-Ionic Guar—Grafting of DMPA on Jaguar S® (Target DS 0.15)

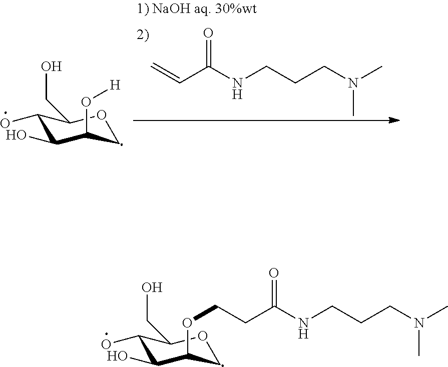

Guiding ratios: NaOH/AGU=0.17; FA AGU=0.25; Waterₜₒₜ/Guar 1.0; Borax free

In a mortar are introduced 30 g of native guar (Jaguar S). 4.20 g of NaOH aqueous solution (30% wt in water) and 27.0 g of distilled water are then mixed with the powder by pestle to obtain a swollen guar powder. The latter is transferred to a 1-L round bottom flask with an integrated counter-blade then heated in a silicon oil bath at 70° C. for 1 hour. 7.37 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.15. The average molar weight of functionalized guar is analyzed by gel permeation chromatography to give M_{w}=1,042 kDa. The biodegradability of the grafted compound is evaluated according to the OECD 301F procedure. The biodegradation expressed by theoretical oxygen demand (ThOD) is 60% after 56 days. The grafted sample is considered as enhanced readily biodegradable.

### Example 2

### Synthesis of a Cationic Guar—Grafting of APTAC on Jaguar S® (Target DS 0.10)

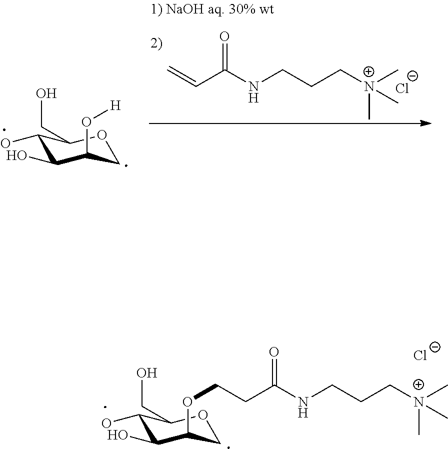

Guiding ratios: NaOH/AGU 0.09; FA AGU 0.08; Waterₜₒₜ/Guar 1.0 with Borax

In a mortar are introduced 6 g of native guar (Jaguar S) and 15 mg of Borax. 0.45 g of NaOH aqueous solution (30% wt in water) and 5.5 g of distilled water are then mixed with the powder by pestle to obtain a swollen guar powder. The latter is transferred to a 500 mL round bottom flask with an integrated counter-blade then heated in a silicon oil bath at 70° C. for 1 hour.

0.816 g of (3-Acrylamidopropyl)trimethylammonium chloride solution (75% wt in water, Sigma-Aldrich, noted as APTAC) are then impregnated to the reaction mixture. All reagents are heated at 70° C. for 6 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.07. The average molar weight of functionalized guar is analyzed by gel permeation chromatography to give M_{w}=1,481 kDa. The biodegradability of the grafted compound is evaluated according to the OECD 301F procedure. The biodegradation expressed by theoretical oxygen demand (ThOD) is 60% after 20 days. The grafted sample is considered as readily biodegradable.

### Example 3

### Synthesis of a Non-Ionic Guar—Grafting of DMEA on Jaguar S® (Target DS 0.15)

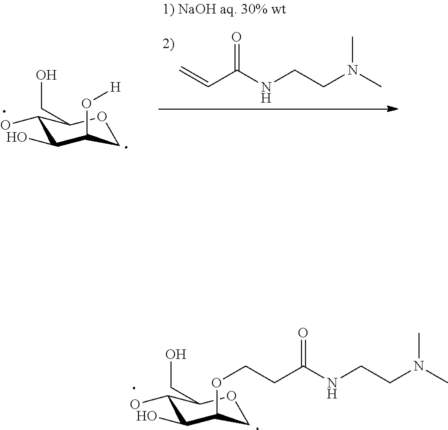

Guiding ratios: NaOH/AGU 0.17; FA AGU 0.19; Waterₜₒₜ/Guar 1.0; Borax free

In a mortar are introduced 30 g of native guar (Jaguar S). 4.20 g of NaOH aqueous solution (30% wt in water) and 27.0 g of distilled water are then mixed with the powder by pestle to obtain a swollen guar powder. The latter is transferred to a 1 L round bottom flask with an integrated counter-blade then heated in a silicon oil bath at 70° C. for 1 hour. 5.00 g of N-(2-(dimethylamino)ethyl)acrylamide (98% purity, Tokyo Chemical Industry, noted as DMEA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.15. The average molar weight of functionalized guar is analyzed by gel permeation chromatography to give Mw=1,039 kDa. The biodegradability of the grafted compound is evaluated according to the OECD 301F procedure. The biodegradation expressed by theoretical oxygen demand (ThOD) is 60% after 16 days. The grafted sample is considered as readily biodegradable.

### Example 4

### Synthesis of a Non-Ionic Guar—Grafting of DMEA on Jaguar S® (Target DS 0.25)

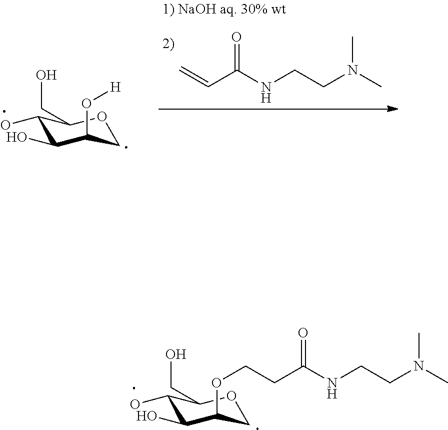

Guiding ratios: NaOH/AGU 0.17; FA AGU 0.31; Waterₜₒₜ/Guar 1.0; Borax free

In a mortar are introduced 30 g of native guar (Jaguar S). 4.20 g of NaOH aqueous solution (30% wt in water) and 27.0 g of distilled water are then mixed with the powder by pestle to obtain a swollen guar powder. The latter is transferred to a 1 L round bottom flask with an integrated counter-blade then heated in a silicon oil bath at 70° C. for 1 hour. 8.31 g of N-(2-(dimethylamino)ethyl)acrylamide (98% purity, Tokyo Chemical Industry, noted as DMEA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.25. The average molar weight of functionalized guar is analyzed by gel permeation chromatography to give Mw=1,346 kDa. The biodegradability of the grafted compound is evaluated according to the OECD 301F procedure. The biodegradation expressed by theoretical oxygen demand (ThOD) is 60% after 50 days. The grafted sample is considered as enhanced readily biodegradable.

### Example 5

### Synthesis of a Anionic Guar—Grafting of DMPA on CMG 145 (Target DS 0.15)

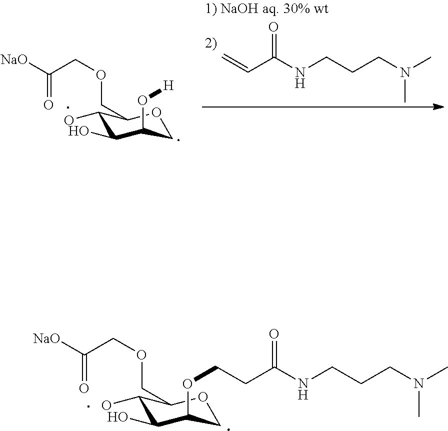

Guiding ratios: NaOH/AGU 0.17; FA AGU 0.25; Waterₜₒₜ/Guar 1.0; with Borax

In a mortar are introduced 30 g of carboxymethyl guar (CMG 145) and 64 mg of Borax. 4.20 g of NaOH aqueous solution (30% wt in water) and 27.0 g of distilled water are then mixed with the powder by pestle to obtain a swollen guar powder. The latter is transferred to a 1 L round bottom flask with an integrated counter-blade then heated in a silicon oil bath at 70° C. for 1 hour. 7.37 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.125. The average molar weight of functionalized guar is estimated to be around 1 MDa.

### Example 6

### Synthesis of a Non-Ionic Guar—Grafting of DMPA on Jaguar HP109 (Target DS 0.25)

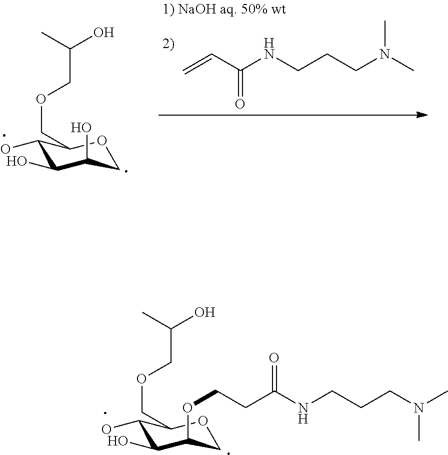

Guiding ratios: NaOH/AGU 0.17; FA AGU 0.50; Waterₜₒₜ/Guar 1.0; Borax free

In a mortar are introduced 20 g of HP guar (Jaguar HP109). 1.40 g of NaOH aqueous solution (50% wt in water) and 16.0 g of distilled water are then mixed with the powder by pestle to obtain a swollen guar powder. The latter is transferred to a 250 mL round bottom flask with an integrated counter-blade then heated in a silicon oil bath at 70° C. for 1 hour. 8.00 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.25. The average molar weight of functionalized guar is estimated to be around 1 MDa.

### Example 7

### Synthesis of a Non-Ionic Guar—Grafting of DMPA on Jaguar HP140 (Target DS 0.25)

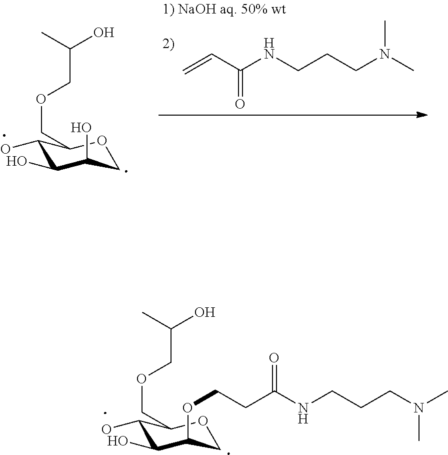

Guiding ratios: NaOH/AGU 0.17; FA AGU 0.50; Waterₜₒₜ/Guar 1.0; Borax free

In a mortar are introduced 20 g of HP guar (Jaguar HP140). 1.30 g of NaOH aqueous solution (50% wt in water) and 16.0 g of distilled water are then mixed with the powder by pestle to obtain a swollen guar powder. The latter is transferred to a 250 mL round bottom flask with an integrated counter-blade then heated in a silicon oil bath at 70° C. for 1 hour. 7.50 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.24. The average molar weight of functionalized guar is estimated to be around 1 MDa.

### Example 8

### Synthesis of a Non-Ionic Guar—Grafting of DMPA on Fenugreek (Target DS 0.18)

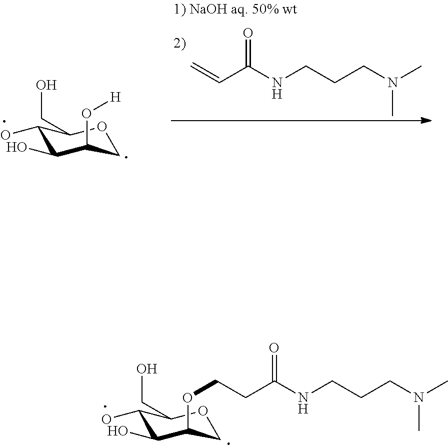

Guiding ratios: NaOH/AGU 0.17; FA AGU 0.40; Waterₜₒₜ/Guar 1.0; Borax free

In a mortar are introduced 20 g of Fenugreek. 1.50 g of NaOH aqueous solution (50% wt in water) and 16.0 g of distilled water are then mixed with the powder by pestle to obtain a swollen guar powder. The latter is transferred to a 250 mL round bottom flask with an integrated counter-blade then heated in a silicon oil bath at 70° C. for 1 hour. 7.00 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.18. The average molar weight of functionalized guar is analyzed by gel permeation chromatography to give M_{w}=780 kDa.

### Example 9

### Synthesis of a Non-Ionic Guar—Grafting of DMPA on Tara Gum (Target DS 0.27)

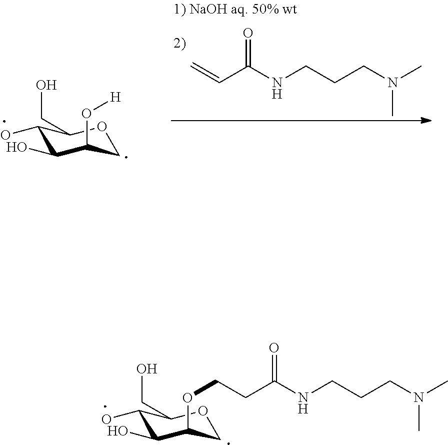

Guiding ratios: NaOH/AGU 0.17; FA AGU 0.40; Waterₜₒₜ/Guar 1.0; Borax free

In a mortar are introduced 20 g of Tara Gum. 1.50 g of NaOH aqueous solution (50% wt in water) and 16.0 g of distilled water are then mixed with the powder by pestle to obtain a swollen guar powder. The latter is transferred to a 250 mL round bottom flask with an integrated counter-blade then heated in a silicon oil bath at 70° C. for 1 hour. 7.00 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.27. The average molar weight of functionalized guar is analyzed by gel permeation chromatography to give M_{w}=700 kDa.

### Example 10

### Synthesis of a Non-Ionic Guar—Grafting of DMPA on Locust Bean (Target DS 0.20)

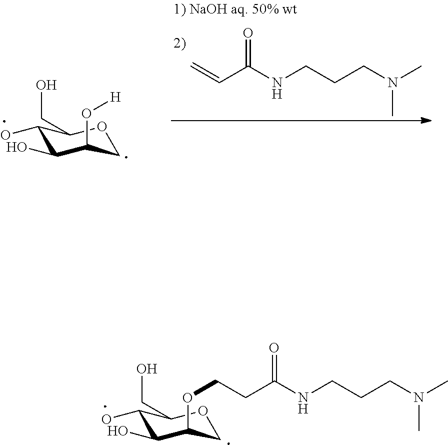

Guiding ratios: NaOH/AGU 0.17; FA AGU 0.40; Waterₜₒₜ/Guar 1.0; Borax free

In a mortar are introduced 20 g of Tara Gum. 1.50 g of NaOH aqueous solution (50% wt in water) and 16.0 g of distilled water are then mixed with the powder by pestle to obtain a swollen guar powder. The latter is transferred to a 250 mL round bottom flask with an integrated counter-blade then heated in a silicon oil bath at 70° C. for 1 hour. 7.00 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.20. The average molar weight of functionalized guar is analyzed by gel permeation chromatography to give M_{w}=440 kDa.

### Example 11

### Synthesis of a Cationic Guar—Grafting of DiQuat-Acrylamide on Jaguar S® (Target DS 0.10)

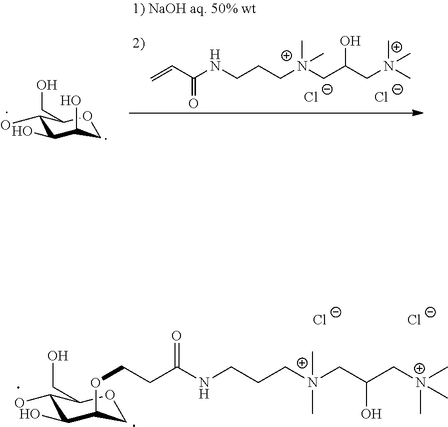

Guiding ratios: NaOH/AGU 0.17; FA AGU 0.13; Waterₜₒₜ/Guar 1.0 with Borax

In a mortar are introduced 20 g of native guar (Jaguar S) and 40 mg of Borax. 1.55 g of NaOH aqueous solution (50% wt in water) and 14.0 g of distilled water are then mixed with the powder by pestle to obtain a swollen guar powder. The latter is transferred to a 250 mL round bottom flask with an integrated counter-blade then heated in a silicon oil bath at 70° C. for 1 hour.

7.50 g of DiQuat-Acrylamide solution (65% wt in water, prepared in-house by quaternization reaction between (3-chloro-2-hydroxypropyl)trimethylammonium chloride and N-(3-(dimethylamino)propyl)acrylamide) are then impregnated to the reaction mixture. All reagents are heated at 70° C. for 6 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.09. The average molar weight of functionalized guar is estimated to be around 1 MDa.

### Example 12

### Synthesis of a Cationic Guar—Grafting of DiQuat-Acrylamide on Jaguar S® (Target DS 0.17)

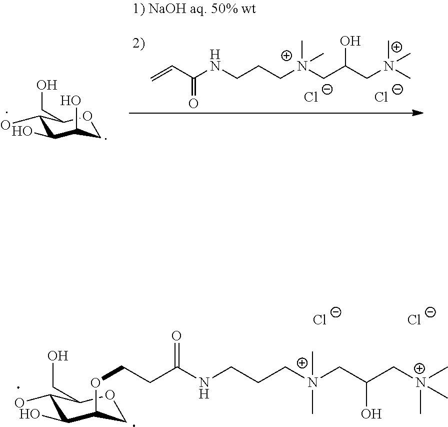

Guiding ratios: NaOH/AGU 0.17; FA AGU 0.25; Waterₜₒₜ/Guar 1.0 with Borax

In a mortar are introduced 20 g of native guar (Jaguar S) and 40 mg of Borax. 1.55 g of NaOH aqueous solution (50% wt in water) and 10.5 g of distilled water are then mixed with the powder by pestle to obtain a swollen guar powder. The latter is transferred to a 250 mL round bottom flask with an integrated counter-blade then heated in a silicon oil bath at 70° C. for 1 hour.

15.00 g of DiQuat-Acrylamide solution (65% wt in water, prepared in-house as mentioned in Example 10) are then impregnated to the reaction mixture. All reagents are heated at 70° C. for 6 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.17. The average molar weight of functionalized guar is analyzed by gel permeation chromatography to give M_{w}=1,330 kDa.

### Example 13

### Synthesis of Cationic Guar—Grafting of DiQuat-Acrylamide on Jaguar S® (Target DS 0.25)

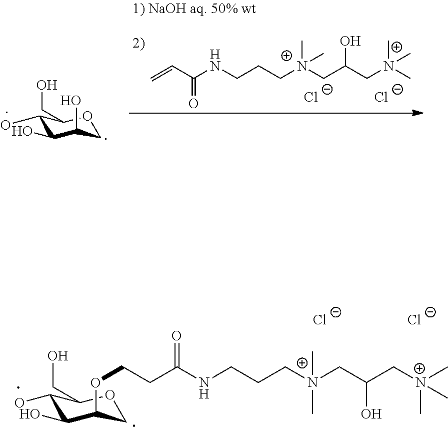

Guiding ratios: NaOH/AGU 0.17; FA AGU 0.50; Waterₜₒₜ/Guar 1.0 with Borax

In a mortar are introduced 20 g of native guar (Jaguar S) and 40 mg of Borax. 1.55 g of NaOH aqueous solution (50% wt in water) and 7.0 g of distilled water are then mixed with the powder by pestle to obtain a swollen guar powder. The latter is transferred to a 250 mL round bottom flask with an integrated counter-blade then heated in a silicon oil bath at 70° C. for 1 hour.

30.00 g of DiQuat-Acrylamide solution (65% wt in water, prepared in-house as mentioned in Example 10) are then impregnated to the reaction mixture. All reagents are heated at 70° C. for 6 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.17. The average molar weight of functionalized guar is analyzed by gel permeation chromatography to give M_{w}=1,530 kDa.

### Example 14

### Synthesis of Cationic Guar—Grafting of DiQuat-Acrylamide on Jaguar HP140 (Target DS 0.10)

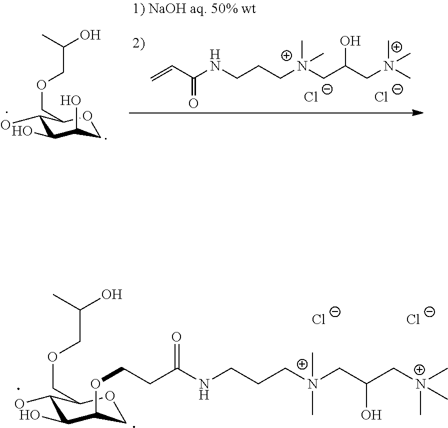

Guiding ratios: NaOH/AGU=0.17; FA AGU=0.15; Waterₜₒₜ/Guar 1.0; Borax free

In a mortar are introduced 20 g of HP guar (Jaguar HP140). 1.30 g of NaOH aqueous solution (50% wt in water) and 13.0 g of distilled water are then mixed with the powder by pestle to obtain a swollen guar powder. The latter is transferred to a 250 mL round bottom flask with an integrated counter-blade then heated in a silicon oil bath at 70° C. for 1 hour.

13.00 g of DiQuat-Acrylamide solution (65% wt in water, prepared in-house as mentioned in Example 10) are then impregnated to the reaction mixture. All reagents are heated at 70° C. for 6 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.09. The average molar weight of functionalized guar is estimated to be around 1 MDa.

### Example 15

### Synthesis of Cationic Guar—Grafting of TriQuat-Acrylamide on Jaguar S® (Target DS 0.040)

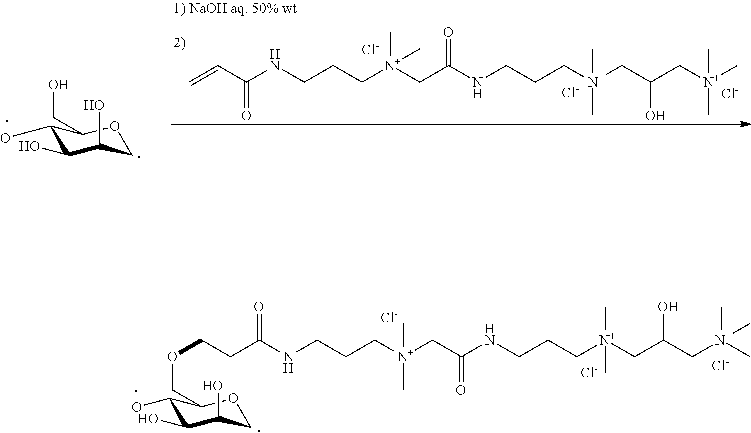

Guiding ratios: NaOH/AGU 0.17; FA AGU 0.11; Waterₜₒₜ/Guar 1.0 with Borax

In a mortar are introduced 20 g of native guar (Jaguar S) and 40 mg of Borax. 1.55 g of NaOH aqueous solution (50% wt in water) and 2.0 g of distilled water are then mixed with the powder by pestle to obtain a swollen guar powder. The latter is transferred to a 250 mL round bottom flask with an integrated counter-blade then heated in a silicon oil bath at 70° C. for 1 hour.

25.00 g of TriQuat-Acrylamide solution (26% wt in water/methanol, prepared in-house in three steps. The first step is the reaction between the N-(3-(dimethylamino)propyl)acrylamide and the methyl chloroacetate to produce the intermediate 1. The second step is the reaction of the intermediate 1 with the dimethylaminopropylamine to produce the intermediate 2. The third step is the quaternization reaction between (3-Chloro-2-hydroxypropyl)trimethylammonium chloride and intermediate 2)) are then impregnated to the reaction mixture. All reagents are heated at 70° C. for 6 hours. At the end of reaction, the solid is washed thoroughly by a solution composed of isopropanol and water (isopropanol/water=7/3; v/v) (50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.040. The average molar weight of functionalized guar is supposed to be around 1 MDa.

### Example 16

### Synthesis of Sultaine Like Guar—Grafting of AMPS on Jaguar C14S (TargetDS=0.14)

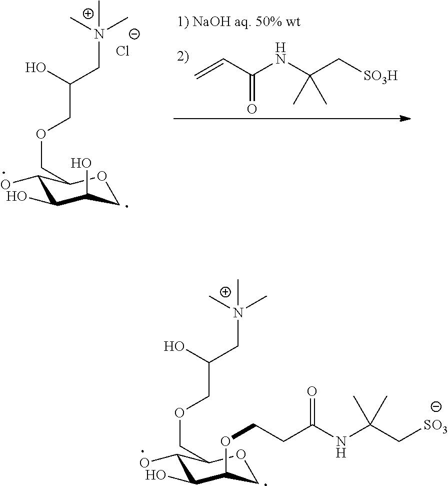

Guiding ratios: NaOH/AGU 0.17; FA AGU 0.29; Waterₜₒₜ/Guar 1.0; Borax free

In a mortar are introduced 20 g of Jaguar C14S. 1.00 g of NaOH aqueous solution (50% wt in water) and 12.5 g of distilled water are then mixed with the powder by pestle to obtain a swollen guar powder. The latter is transferred to a 250 mL round bottom flask with an integrated counter-blade then heated in a silicon oil bath at 70° C. for 1 hour. 9.10 g of 2-acrylamido-2-methylpropane sulfonic acid solution (50% wt in water, prepared in-house, noted as AMPS) are then impregnated to the reaction mixture. All reagents are heated at 70° C. for 6 hours. At the end of reaction, the solid is washed thoroughly by a solution composed of isopropanol and water (isopropanol/water=7/3; v/v) (50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.14. The average molar weight of functionalized guar is analyzed by gel permeation chromatography to give M_{w}=600 kDa. The biodegradability of the grafted compound is evaluated according to the OECD 301F procedure. The biodegradation expressed by theoretical oxygen demand (ThOD) is 60% after 47 days. The grafted sample is considered as enhanced readily biodegradable.

### Part II: Quaternization of Amide Amine Guar

### Example 17

### Quaternization of Amide Amine Guar with 2-(2-chloroethoxy)ethanol

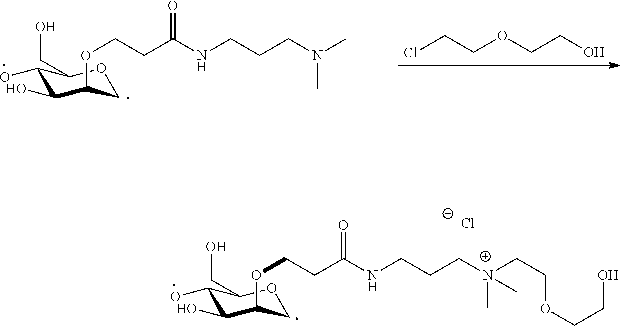

Guiding ratios: QA (quaternization agent)/TA (tertiary amine)=6.73

In a mortar are introduced 10 g of Amide Amine Guar (DS=0.15; 8.10 mmol of tertiary amine). 10 g of distilled water are then mixed with the powder by pestle to obtain a swollen guar powder. The latter is transferred to a 500 mL round bottom flask with an integrated counter-blade.

6.90 g of 2-(2-chloroethoxy)ethanol (Sigma-Aldrich, 99% purity, 54.55 mmol) are then impregnated to the swollen guar. All reagents are heated at 70° C. for 16 hours. At the end of reaction, the solid is washed thoroughly by a solution composed of isopropanol and water (isopropanol/water=7/3; v/v)(100 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring. The resulting solution is analyzed by ¹H NMR.

The advancement of quaternization is higher than 99% in this case.

### Example 18

### Quaternization of Amide Amine Guar with 3-chloropropanol

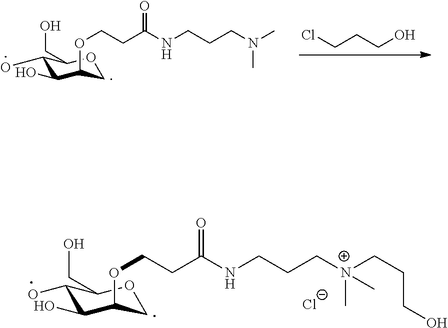

Guiding ratios: QA (quaternization agent)/TA (tertiary amine)=1.50

In a mortar are introduced 5 g of Amide Amine Guar (DS=0.15; 4.05 mmol of tertiary amine). 5 g of distilled water are then mixed with the powder by pestle to obtain a swollen guar powder. The latter is transferred to a 500 mL round bottom flask with an integrated counter-blade.

0.58 g of 3-chloropropanol (Sigma-Aldrich, 98% purity, 6.0 mmol) are then impregnated to the swollen guar. All reagents are heated at 70° C. for 16 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring. The resulting solution is analyzed by ¹H NMR.

The advancement of quaternization is 94% in this case.

### Example 19

### Quaternization of Amide Amine Guar with (+)-3-chloro-1,2-propanediol

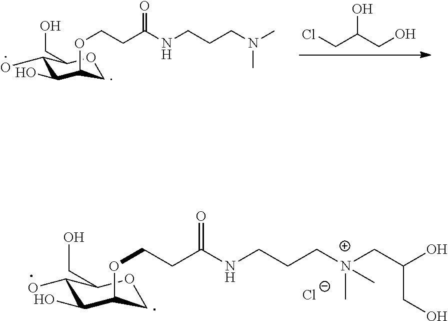

Guiding ratios: QA (quaternization agent)/TA (tertiary amine)=1.50

In a mortar are introduced 5 g of Amide Amine Guar (DS=0.15; 4.05 mmol of tertiary amine). 5 g of distilled water are then mixed with the powder by pestle to obtain a swollen guar powder. The latter is transferred to a 500 mL round bottom flask with an integrated counter-blade.

0.68 g of (±)-3-chloro-1,2-propanediol (Sigma-Aldrich, 98% purity, 6.0 mmol) are then impregnated to the swollen guar. All reagents are heated at 70° C. for 16 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR. The advancement of quaternization is higher than 99% in this case.

### Example 20

### Quaternization of Amide Amine Guar with (3-chloro-2-hydroxypropyl)-trimethylammonium Chloride

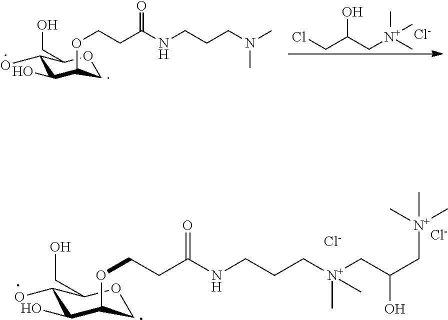

Guiding ratios: QA (quaternization agent)/TA (tertiary amine)=2.0

In a mortar are introduced 5 g of Amide Amine Guar (DS=0.15; 4.05 mmol of tertiary amine). 4.20 g of distilled water are then mixed with the powder by pestle to obtain a swollen guar powder. The latter is transferred to a 500 mL round bottom flask with an integrated counter-blade.

2.30 g of (3-chloro-2-hydroxypropyl)trimethylammonium chloride solution (Tokyo Chemical Industry, 65% wt in water, 6.0 mmol) are then impregnated to the swollen guar. All reagents are heated at 70° C. for 16 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring. The resulting solution is analyzed by ¹H NMR.

The advancement of quaternization is 89% in this case.

### Example 21

### Quaternization of Amide Amine Guar with Sodium 2-chloroacetate

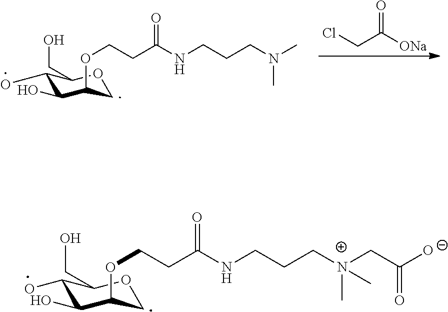

Guiding ratios: QA (quaternization agent)/TA (tertiary amine)=1.50

In a mortar are introduced 5 g of Amide Amine Guar (DS=0.21; 5.39 mmol of tertiary amine). 0.96 g of sodium 2-chloroacetate (Sigma-Aldrich, 99% purity, 8.0 mmol) are dissolved in 5 g of distilled water. The resulting solution is then mixed with the powder by pestle to obtain a swollen guar powder. The latter is transferred to a 500 mL round bottom flask with an integrated counter-blade. All reagents are heated at 70° C. for 16 hours. At the end of reaction, the solid is washed thoroughly by a solution composed of isopropanol and water (isopropanol/water=7/3; v/v) (50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR. The advancement of quaternization is higher than 99% in this case. The biodegradability of the grafted compound is evaluated according to the OECD 301F procedure. The biodegradation expressed by theoretical oxygen demand (ThOD) is 75% after 60 days. The grafted sample is considered as enhanced readily biodegradable.

### Example 22

### Quaternization of Amide Amine Guar with Sodium 3-chloro-2-hydroxypropane-1-sulfonate

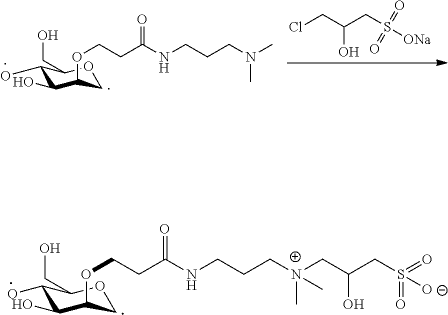

Guiding ratios: QA (quaternization agent)/TA (tertiary amine)=1.50

In a mortar are introduced 5 g of Amide Amine Guar (DS=0.15; 4.05 mmol of tertiary amine). 1.31 g of sodium 3-chloro-2-hydroxypropane-1-sulfonate hemi hydrated (Alfa Aesar, 98% purity, 6.0 mmol) are dissolved in 5 g of distilled water. The resulting solution is then mixed with the powder by pestle to obtain a swollen guar powder. The latter is transferred to a 500 mL round bottom flask with an integrated counter-blade. All reagents are heated at 70° C. for 16 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR. The advancement of quaternization is higher than 99% in this case.

### Example 23

### Quaternization of Amide Amine Guar with Sodium 2-chloroethanesulfonate

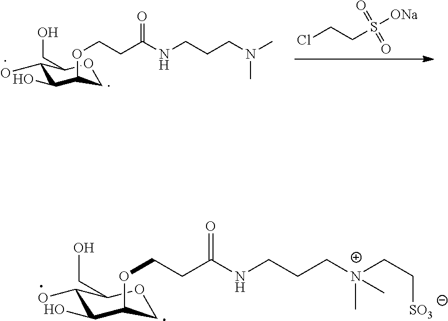

Guiding ratios: QA (quaternization agent)/TA (tertiary amine)=1.50

In a mortar are introduced 5 g of Amide Amine Guar (DS=0.15; 4.05 mmol of tertiary amine). 1.31 g of sodium 2-chloroethanesulfonate monohydrate (Sigma-Aldrich, 98% purity, 6.0 mmol) are dissolved in 5 g of distilled water. The resulting solution is then mixed with the powder by pestle to obtain a swollen guar powder. The latter is transferred to a 500 mL round bottom flask with an integrated counter-blade. All reagents are heated at 70° C. for 16 hours. At the end of reaction, the solid is washed thoroughly by a solution composed of isopropanol and water (isopropanol/water=7/3; v/v) (50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR. The advancement of quaternization is 81% in this case.

### Example 24

### Quaternization of Amide Amine Guar with 3-bromopropanesulfonic Acid Sodium Salt

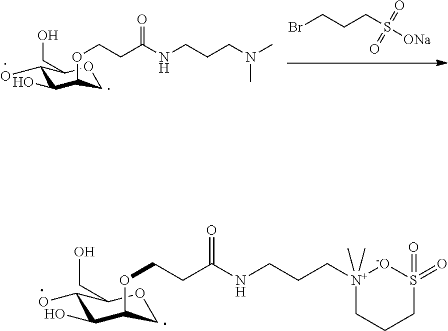

Guiding ratios: QA (quaternization agent)/TA (tertiary amine)=1.50

In a mortar are introduced 5 g of Amide Amine Guar (DS=0.15; 4.05 mmol of tertiary amine). 1.40 g of 3-bromopropanesulfonic acid sodium salt (Sigma-Aldrich, 97% purity, 6.0 mmol) are dissolved in 5 g of distilled water. The resulting solution is then mixed with the powder by pestle to obtain a swollen guar powder. The latter is transferred to a 500 mL round bottom flask with an integrated counter-blade. All reagents are heated at 70° C. for 16 hours. At the end of reaction, the solid is washed thoroughly by a solution composed of isopropanol and water (isopropanol/water=7/3; v/v) (50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR. The advancement of quaternization is higher than 99% in this case. The biodegradability of the grafted compound is evaluated according to the OECD 301F procedure. The biodegradation expressed by theoretical oxygen demand (ThOD) is 67% after 28 days. The grafted sample is considered as readily biodegradable.

### Example 25

### Quaternization of Amide Amine Guar with Benzyl Chloride

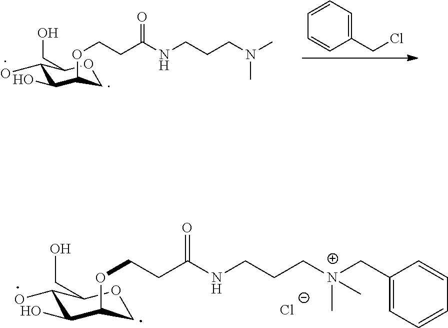

Guiding ratios: QA (quaternization agent)/TA (tertiary amine)=1.50

In a mortar are introduced 5 g of Amide Amine Guar (DS=0.15; 4.05 mmol of tertiary amine). 5 g of distilled water are then mixed with the powder by pestle to obtain a swollen guar powder. The latter is transferred to a 500 mL round bottom flask with an integrated counter-blade.

0.75 g of benzyl chloride (Sigma-Aldrich, 99% purity, 6.0 mmol) are then impregnated to the swollen guar. All reagents are heated at 70° C. for 16 hours. At the end of reaction, the solid is washed thoroughly by a solution composed of isopropanol and water (isopropanol/water=7/3; v/v)(50 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR. The advancement of quaternization is 96% in this case.

### Part III: Other Examples

### Example 26

### Synthesis of N-(3-(methylthio)propel)acrylamide

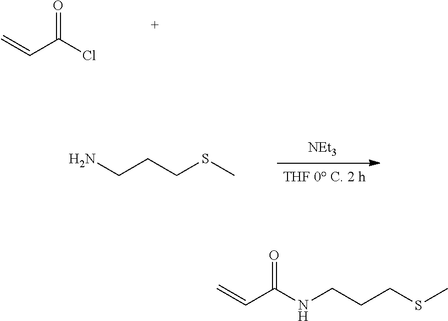

To a two-necked round bottom flask are added 60 mL of anhydrous tetrahydrofuran (Sigma-Aldrich, >99.9% purity) and 5.68 g of triethylamine (Sigma-Aldrich, >99.5% purity, 55.89 mmol, 1.2 equiv.) under stirring. Then, 5 g of 3-methylthiopropylamine (Tokyo Chemical Industry, 98% purity, 46.58 mmol, 1 equiv.) are added to this solution under argon flow. The amine solution is cooled to 0° C. using an ice bath. Meanwhile, 5.22 g of acryloyl chloride (Sigma-Aldrich, >97% purity, 55.89 mmol, 1.2 equiv.) are firstly diluted in 20 mL of anhydrous tetrahydrofuran then added to the amine solution through a dropping funnel at 0° C. The reaction mixture is stirred under argon flow at 0° C. for 2 hours. White precipitate is immediately observed upon addition of acryloyl chloride. At the end of reaction, the white precipitate is filtered under vacuum and the filtration cake is washed with 15 mL of anhydrous tetrahydrofuran twice. The organic filtrates are combined and then concentrated under vacuum to give a yellow oil. The crude product is purified by silica gel column chromatography using cyclohexane and ethyl acetate from 100% cyclohexane to cyclohexane/ethyl acetate=50%/50% (v,v) to give N-(3-(methylthio)propyl)acrylamide as colorless oil (5.97 g, yield=81%).

### Example 27

### Synthesis of Amide Thioether Guar—Grafting of MTPA on Jaguar S®

Guiding ratios: NaOH/AGU 0.17; FA AGU 0.25; Waterₜₒₜ/Guar 1.0; Borax free

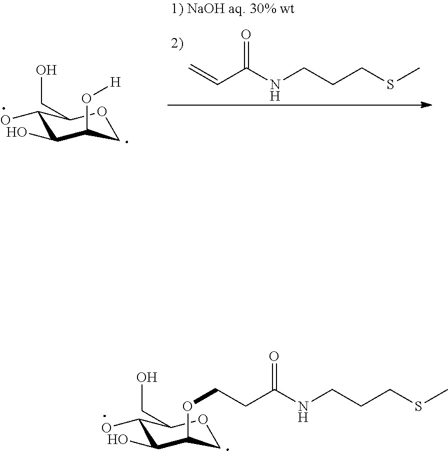

In a mortar are introduced 20 g of native guar (Jaguar S). 2.80 g of NaOH aqueous solution (30% wt in water) and 18.0 g of distilled water are then mixed with the powder by pestle to obtain a swollen guar powder. The latter is transferred to a 1 L round bottom flask with an integrated counter-blade then heated in a silicon oil bath at 70° C. for 1 hour. 5.0 g of N-(3-(methylthio)propyl)acrylamide (home-made reagent, noted as MTPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 10 mg of functionalized guar are mixed with 1 mL of heavy water (D₂O) using a mini shaker without acidic hydrolysis. The resulting solution is analyzed by ¹H NMR to give DS=0.07. The average molar weight of functionalized guar is estimated to be around 1 MDa.

### Example 28

### Synthesis of N,N-bis(3-(dimethylamino)propyl)acrylamide

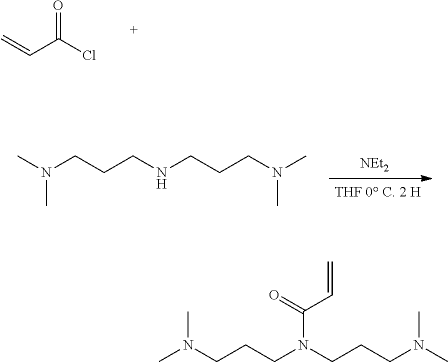

To a two-necked round bottom flask are added 60 mL of anhydrous tetrahydrofuran (Sigma-Aldrich, >99.9% purity) and 3.51 g of triethylamine (Sigma-Aldrich, >99.5% purity, 34.53 mmol, 1.1 equiv.) under stirring. Then, 6 g of 3,3′-iminobis(N,N-dimethylpropylamine) (Tokyo Chemical Industry, 97% purity, 31.39 mmol, 1 equiv.) are added to this solution under argon flow. The amine solution is cooled to 0° C. using an ice bath. Meanwhile, 3.22 g of acryloyl chloride (Sigma-Aldrich, >97% purity, 34.53 mmol, 1.1 equiv.) are firstly diluted in 20 mL of anhydrous tetrahydrofuran then added to the amine solution through a dropping funnel at 0° C. The reaction mixture is stirred under argon flow at 0° C. for 2 hours. White precipitate is immediately observed upon addition of acryloyl chloride. At the end of reaction, the white precipitate is filtered under vacuum and the filtration cake is washed with 15 mL of anhydrous tetrahydrofuran twice. The organic filtrates are combined and then concentrated under vacuum to give a yellow oil without further purification. The crude oil is directly used for the grafting step.

### Example 29

### Synthesis of Amide Bis-DMAPA Guar—Grafting of N,N-bis(3-(dimethylamino)propyl)acrylamide on Jaguar S®

Guiding ratios: NaOH/AGU 0.17: Waterₜₒₜ/Guar 1.0: Borax free

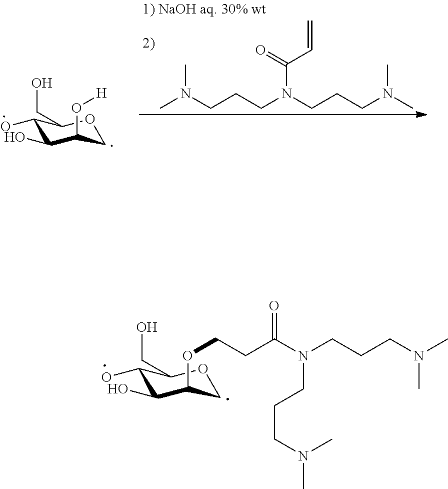

In a mortar are introduced 10 g of native guar (Jaguar S). 1.40 g of NaOH aqueous solution (30% wt in water) and 9.0 g of distilled water are then mixed with the powder by pestle to obtain a swollen guar powder. The latter is transferred to a 500 mL round bottom flask with an integrated counter-blade then heated in a silicon oil bath at 70° C. for 1 hour. 2.55 g of the crude N,N-bis(3-(dimethylamino)propyl)acrylamide (home-made reagent) are then impregnated to the reaction mixture. All reagents are heated at 70° C. for 6 hours. At the end of reaction, the solid is washed thoroughly by a solution composed of isopropanol and water (isopropanol/water=7/3; v/v) (100 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.03. The average molar weight of functionalized guar is estimated to be around 1 MDa.

### Example 30

### Synthesis of a Non-Ionic Starch—Grafting of DMPA on Starch from Corn

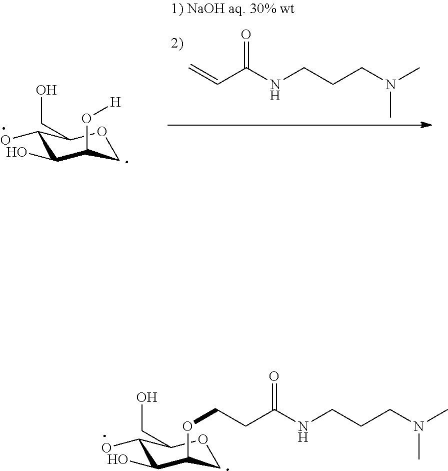

Guiding ratios: NaOH/AGU 0.17; FA AGU 0.25; Waterₜₒₜ Starch 0.4; Borax free

In a mortar are introduced 20 g of starch from corn (product of Sigma-Aldrich, S9679-250G). 2.80 g of NaOH aqueous solution (30% wt in water) and 6.0 g of distilled water are then mixed with the powder by pestle to obtain a swollen starch powder. The latter is transferred to a 1 L round bottom flask with an integrated counter-blade then heated in a silicon oil bath at 70° C. for 1 hour. 4.92 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized starch are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.05.

### Example 31

### Synthesis of a Non-Ionic Cellulose—Grafting of DMPA on Cellulose Powder

Guiding ratios: NaOH/AGU 0.17; FA AGU 0.25; Waterₜₒₜ Cellulose 1.0; Borax free

In a mortar are introduced 10 g of cellulose powder (product of Sigma-Aldrich, 435236-250G). 1.40 g of NaOH aqueous solution (30% wt in water) and 9.0 g of distilled water are then mixed with the powder by pestle to obtain a swollen cellulose powder. The latter is transferred to a 1 L round bottom flask with an integrated counter-blade then heated in a silicon oil bath at 70° C. for 1 hour. 2.50 g of N-(3-(dimethylamino)propyl)acrylamide (98% purity, Tokyo Chemical Industry, noted as DMPA) are then impregnated to the reaction mixture. All reagents are heated at 70° C. for 6 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized cellulose are mixed with 1 mL of heavy water (D₂O) and 0.3 mL of sulfuric acid-d2 solution (D₂SO₄) for hydrolysis at 90° C. during 2 hours under stirring.

The resulting solution is analyzed by ¹H NMR to give DS=0.08

### Example 32

### Synthesis of a Non-Ionic Guar—Grafting of DMPA on Jaguar S® (Before Optimization)

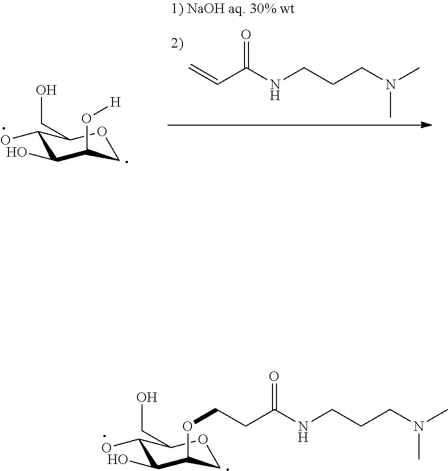

Guiding ratios: NaOH/AGU 0.50; FA AGU 0.50; Waterₜₒₜ/Guar 0.65; with Borax

In a mortar are introduced 20 g of native guar (Jaguar S) and 43 mg of Borax. 8.22 g of NaOH aqueous solution (30% wt in water) and 7.20 g of distilled water are then mixed with the powder by pestle to obtain a swollen guar powder. The latter is transferred to a 1 L round bottom flask with an integrated counter-blade then heated in a silicon oil bath at 70° C. for 1 hour. 9.83 g of N-(3-(dimethylamino)propyl)acrylamide (98% purity, Tokyo Chemical Industry, noted as DMPA) are then impregnated to the reaction mixture. All reagents are heated at 70° C. for 5 hours. At the end of reaction, the solid is washed thoroughly by a solution composed of isopropanol and water (isopropanol/water=7/3; v/v) (200 mL 5 times) then dried in an oven at 50° C. under atmospheric pressure. After complete drying, 20 mg of functionalized guar are mixed with 1 mL of heavy water (D₂O) and 0.6 g of trifluoroacetic acid-d (TFA-d) for hydrolysis at 90° C. during 2 hours under stirring.

The resulting solution is analyzed by ¹H NMR to give DS=0.095. The average molar weight of functionalized guar is analyzed by gel permeation chromatography to give M_{w}=112 kDa.

### Part IV: Flocculation Performances and Combing Force Reduction Performances

In the study below we compared containing Guar-Amide-C₂-Amine (DS=0.25) versus shampoos each containing Jaguar C14S and Jaguar C₁₇ respectively. The containing Guar-Amide-C₂-Amine (DS=0.25) (see Example 4) had the same chemical structure as in example 3 but with a higher quaternization (DS).

### Shampoo Formulation Procedure

1) Disperse the polymer in water under agitation at 400 rpm then add a little 50% citric acid to hydrate the guar: mix for 20 min at 150 rpm.
2) Add progressively the CAPB (Mackam 50 ULB) under agitation and mix until the mixture is homogeneous (about 10 min).
3) Add progressively the SLES (Rhodapex ESB 30HA1) under agitation and mix until the mixture is homogeneous (about 20 min).
4) Add the phenoxyethanol.
5) Once the phenoxyethanol is added, check the pH and adjust it with citric acid to reach 5.1-5.3.
6) Add the NaCl and stir until the mixture is homogeneous.
   Formulation of Shampoos Containing Jaguar C14S, Jaguar C₁₇ and Guar-Amide-C₂-Amine (DS=0.25) for Flocculation Assessment:

| | % active in |
|---|---|
| Ingredients | formulation |
| SLES | 12 |
| CAPB | 2 |
| Cationic Galactomannan | 0.3 |
| Phenoxyethanol | 0.6 |
| Citric acid | 0.4 |
| Sodium chloride | 1.5 |
| Water | qs 100 |

Formulation of Shampoos Containing Jaguar C14S, Jaguar C₁₇ and Guar-Amide-C₂-Amine (DS=0.25) for Combing Assessment:

| | % active in |
|---|---|
| Ingredients | formulation |
| SLES | 12 |
| CAPB | 2 |
| Cationic Galactomannan | 0.5 |
| Phenoxyethanol | 0.6 |
| Citric acid | 0.4 |
| Sodium chloride | 1.5 |
| Water | qs 100 |

### Polymer Flocculation Profile Procedure

In a small glass container (vial 30 mL), we prepared the 10 grams of shampoo dilution (see chart below). We prepared 5 different samples of shampoo diluted from factor 2 to 10. We mixed with a magnetic stirrer and after 5 minutes (use a timer to measure mixing time), we measured transmission % (t %) in a 10×10 mm cell at 600 nm using a Perkin Elmer lambda bio 40 UV spectrophotometer.

| | | | | | |
|---|---|---|---|---|---|
| Dilution factor | 2 | 4 | 6 | 8 | 10 |
| Formula (g) | 5 | 2.5 | 1.67 | 1.25 | 1 |
| Water (g) | 5 | 7.5 | 8.33 | 8.75 | 9 |

Start the measurement of the D2 dilution precisely at 5 minutes, follow the measurement of the T % of the other D4 dilutions; D6; D8.

For the measurement of T % of D10, wait until you have been at precisely 7 minutes of agitation.

### Combing Force/Work Measurement Procedure

The experiment was carried out using a DIASTRON UV1000 and method MTT175 as specified by the instrument manufacturer (Diastron).

| PRETREATMENT | Wetting under water 1 min under | | | At 37° C. |
|---|---|---|---|---|
| | a flow rate of flow (3.6 L/min) | | | |
| | Massage the hair for | | | |
| | 1 min with 2 mL | | | |
| | of solution of 14% wt | | | |
| | SLES at pH = 5 | | | |
| | Rinse for 30 sec | | | |
| | Massage the hair for | | | |
| | 1 min with 2 mL | | | |
| | of solution of 14% wt | | | |
| | SLES at pH = 5 | | | |
| | Rinse for 1 min | | | |
| | Wring the length of the hair | | | |
| | twice between two fingers | | | |
| | Detangle with a comb | | | |
| DIASTRON USED | Detangle with a comb | | | |
| COMBING | 1- Dip the tress in water and remove | | | |
| PROCEDURE | excess water before tress measurement, | | | |
| | Detangle once using a wide space teeth | | | |
| | comb on each side of the hair | | | |
| | tress and realign fibers | | | |
| | 2- Hang tight to the device | | | |
| | 3- Set combing parameters: | | | |
| | start position: | 30 | mm | |
| | tress length: | 175 | mm | |
| | rate: | 300 | mm/min | |
| | maximum | 2000 | gmf | |
| | force: | | | |

Each pretreated tress is measured ten times and then the average of the 10 measurements is calculated.

### Shampooing Application x2

Wetting under water 1 min under a flow rate of flow (3.6 L/min).

Massage the hair for 45 seconds with 0.8 g of shampoo test formulation.

Rinse for 30 seconds.

Repeat this stage one more time.

Diastron used: UV 1000

### Combing Procedure

1—Dip the tress in water and remove excess water before tress measurement, detangle once using a wide space teeth comb on each side of the hair tress and realign fibers.
2—Hang tight to the device.
3—Set combing parameters: start position: 30 mm/tress length: 175 mm/rate 300 mm/min/maximum force: 2000 gmf.

Each test formulation is assessed in triplicate and each of the triplicates is measured ten times and then we take the average of the 10 measurements.

The percentage combing force/work reduction is calculated by comparison to the combing force/work measured for the same hair tresses before treatment with the test formulations.

### Flocculation Profile Results

Flocculation behavior of shampoos shampoo containing Guar-Amide-C₂-Amine (DS=0.25) versus shampoos each containing Jaguar C14S and Jaguar C₁₇ respectively

| | Transmittance | | |
|---|---|---|---|
| | (%) | Transmittance | Transmittance |
| | Guar-Amide- | (%) | (%) |
| | C2-Amine | Jaguar | Jaguar |
| | (DS = 0.25) | C14S | C17 |
| Dilution factor 0 | 78.0 | 80.1 | 73.1 |
| Dilution factor 2 | 4.9 | 75.4 | 51.4 |
| Dilution factor 4 | 8.2 | 47.4 | 15.8 |
| Dilution factor 6 | 15.7 | 33.4 | 22.8 |
| Dilution factor 8 | 28.6 | 39.7 | 36.0 |
| Dilution factor 10 | 46.9 | 50.6 | 47.0 |

Shampoos containing cationic polymers when in application undergo dilution. During and because of this dilution, a polymer/surfactant complex form which deposits on the hair. Polymer/surfactant complexes are known to provide a conditioned feel in the wet state. They are also known to increase the deposition of oils from shampoos. As a general rule, the higher the formation of these complexes the higher the conditioning imparted to the hair surface.

From the flocculation curves then it is observed that they start at high transmission and go through a minimum before increasing in transparency again. The deeper and broader the minimum in the curve, the higher and more sustained the formation of flocs.

In the data above we see that Guar-Amide-C₂-Amine (DS=0.25) exhibits a deeper and broader minimum occurring earlier on the dilution axis than the commercial examples of cationic guars. It can be then inferred that the Guar-Amide-C₂-Amine (DS=0.25) has a higher propensity to form flocs that would act to impart a conditioned feel on the hair surface.

### Combing Performance Results

Combing force reduction performance comparison of shampoo containing Guar-Amide-C₂-Amine (DS=0.25) versus shampoos each containing Jaguar C14S and Jaguar C₁₇ respectively.

| | Guar-Amide- | | |
|---|---|---|---|
| | C2-Amine | Jaguar | Jaguar |
| | (DS = 0.25) | C14S | C17 |
| % Combing | 30.7 ± 5.8 | 34.6 ± 2.5 | 43.8 ± 5.3 |
| force reduction | | | |

The combing performance of the shampoo containing Guar-Amide-C₂-Amine (DS=0.25) versus shampoos each containing Jaguar C14S and Jaguar C₁₇ is shown. The lower the values the lower amount of force required to run a comb through the hair, which is a further indication of conditioning. It becomes apparent that this novel nominally non-ionic guar based polymer provides significant conditioning, as exemplified by combing work/force reduction, on the same order as the widely and commonly used commercial grades of Jaguar C14S and Jaguar C₁₇ conditioning polymers.

1. A grafted polysaccharide of formula I 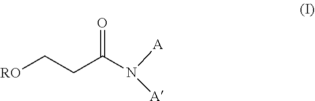
wherein
RO is a deprotonated polysaccharide group,
A is —(CR′R″)ₙ-A″,
A′ is H, alkyl or A, wherein when A′ is A the two As are identical or different,
R′ and R″, which are identical or different at each occurrence, are H or an alkyl group,
n is an integer from 1 to 20,
A″ is either NR₁R₂ N+R₁R₂R₃ or (CR₄R₅)ₘXOₖY, wherein
R₁, R₂ and R₃, which are identical or different, are selected from the group consisting of hydrogen, aliphatic, cycloaliphatic, aryl-aliphatic groups, optionally substituted and/or interrupted by one or more heteroatoms or heteroatom containing groups, heteroaliphatic cycle formed by R₁ and R₂ with the N atom, and combinations thereof,
R₄ and R₅, which are identical or different, are selected from the group consisting of hydrogen and alkyl groups, optionally substituted and/or interrupted by one or more heteroatoms or heteroatom containing groups,
m is an integer from 1 to 20,
X is O, S or C
k is 0, 2 or 3, and
Y is hydrogen, a C₁-C₆ alkyl group, or a negative charge.

2. The grafted polysaccharide of formula I according to claim 2, wherein RO is a deprotonated galactomannan or derivatives thereof.

3. The grafted polysaccharide of formula I according to claim 1, wherein RO is a deprotonated guar or derivatives thereof and
A′ is H
R′ and R″ are H
n is 2 or 3, and
A″ is N+R₁R₂R₃ with
R₁ and R₂ being methyl groups and
R₃ being selected from the group consisting of H, —(CH₂—CH₂O)₂—H, —(CH₂)₃—OH, —CH₂—CH(OH)—CH₂—OH, —CH₂-Ph, —CH₂—COO—, —CH₂—CH(OH)—CH₂—SO₃—, —CH₂—CH₂—SO₃—
—CH₂—CH(OH)—CH₂—N+(CH₃)₃ and
—CH₂—CO—NH—CH₂—CH₂—CH₂—N+(CH₃)₂—CH₂—CH(OH)—CH₂—N+(CH₃)₃;
or alternatively,
A′ is H
R′ and R″ are methyl,
A″ is (CR₄R₅)ₘXOₖY,
R₄ and R₅ are hydrogen
m is an integer from 1 to 3,
X is S,
k is 3, and
Y is hydrogen, a C₁-C₆ alkyl group or a negative charge.

4. A process for producing a grafted polysaccharide of formula I as defined in claim 1, by reacting a deprotonated polysaccharide of formula RO⁻ with a functionalization agent of formula II

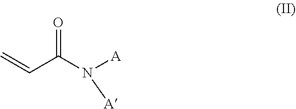

5. The process according to claim 4, wherein in a first step a polysaccharide is deprotonated to obtain the deprotonated polysaccharide of formula RO⁻ and in a second step the deprotonated polysaccharide reacts with the functionalization agent of formula II.

6. The process according to claim 5, wherein the polysaccharide is mixed with a complexing agent prior deprotonation of the polysaccharide.

7. The process according to claim 5, wherein the polysaccharide is swollen with water and an alkaline aqueous solution comprising a base to catalyze the deprotonation reaction of the polysaccharide.

8. The process according to claim 7, wherein the weight ratio of total water content to polysaccharide is from 0.5 to 3 g/g.

9. The process of claim 7, wherein the base is sodium hydroxide.

10. The process according claim 7, wherein the molar ratio of the base to anhydroglucose unit of the deprotonated polysaccharide is from 0.1 to 1.5.

11. The process according to claim 5, wherein the deprotonation reaction is carried out at a temperature of 0 to 80° C. for a duration of 0.5 to 3 hours.

12. The process according to claim 4, wherein the molar ratio of the functionalization agent of formula II to the anhydroglucose unit of the deprotonated polysaccharide is from 0.05 to 3.

13. The process according to claim 4, wherein the deprotonated polysaccharide is reacted with the functionalization agent of formula II at a temperature of 50° C. to 80° C. for a duration of 2 to 48 hours.

14. A process for producing a polysaccharide having a quaternized amine group, by reacting a grafted polysaccharide of formula I, obtained by a process as defined in claim 9 and wherein A″ is NR₁R₂, with a quaternization agent having the formula III
X′—R₆ (III)
wherein
X′ is a leaving group and
R₆ is a moiety selected from the group consisting of aliphatic, aromatic, alkylaryl, and alcohol groups, optionally substituted and/or interrupted by one or more heteroatoms or heteroatom containing groups.

15. The process for producing a polysaccharide having a quaternized amine group according to claim 14, wherein
X′ is an halogen and
R₆ is selected from the group consisting of 2-(2-chloroethoxy)ethanol, 3-chloro-1-propanol, (±)-3-chloro-1,2-propanediol, (3-chloro-2-hydroxypropyl)-trimethylammonium chloride, sodium chloroacetate, sodium 3-chloro-2-hydroxypropane-1-sulfonate, sodium 2-chloroethanesulfonate, and benzyl chloride.

16. A composition comprising at least a grafted polysaccharide of formula (I) according to claim 1.

17. The composition according to claim 16 wherein it is a home and personal care composition.

18. The process according to claim 7, wherein the weight ratio of total water content to polysaccharide is from 0.5 to 2 g/g.
